(19) United States
(12) Patent Application Publication
(10) Pub. No.: US 2015/0311923 A1
(43) Pub. Date: Oct. 29, 2015

(54) TECHNIQUES FOR DIFFERENTIATING BETWEEN SIGNALS OF DIFFERENT RADIO ACCESS TECHNOLOGIES

(71) Applicant: QUALCOMM Incorporated, San Diego, CA (US)

(72) Inventors: Nachiappan VALLIAPPAN, San Diego, CA (US); Ahmed Kamel SADEK, San Diego, CA (US)

(21) Appl. No.: 14/491,797

(22) Filed: Sep. 19, 2014

Related U.S. Application Data
(60) Provisional application No. 61/984,469, filed on Apr. 25, 2014.

(51) Int. Cl. H04B 1/00; H04W 16/14

(52) U.S. Cl. CPC H04B 1/0053; H04W 16/14; H04W 88/10

(57) ABSTRACT

Systems and methods for differentiating between LTE and Wi-Fi signals based on distinguishing characteristics thereof are disclosed. A radio or receiver configured for processing signals associated with a first RAT can detect a signal associated with a second RAT, wherein the signals associated with the first RAT and the signal associated with the second RAT are received over a communications medium using an unlicensed frequency spectrum. One or more characteristics of the decoded signal can be detected or identified, such as a pilot or reference signal pattern, an interframe spacing, a cyclic prefix or guard interval structure, a bandwidth utilization, etc. The decoded signal can be determined as relating to the second RAT based at least in part on determining that the one or more characteristics correspond to the second RAT.

### CLAIM OF PRIORITY UNDER 35 U.S.C. §119

The present application for patent claims priority to Provisional Application No. 61/984,469 entitled “METHOD AND APPARATUS FOR DIFFERENTIATING BETWEEN LTE AND WI-FI SIGNALS” filed Apr. 25, 2014, and assigned to the assignee hereof and hereby expressly incorporated by reference herein.

### BACKGROUND

Aspects of this disclosure relate generally to telecommunications, and more particularly to communicating in environments employing multiple radio access technologies.

A wireless communication network may be deployed to provide various types of services (e.g., voice, data, multimedia services, etc.) to users within a coverage area of the network. In some implementations, one or more access points (e.g., corresponding to different cells) provide wireless connectivity for access terminals (e.g., cell phones) that are operating within the coverage of the access point(s). In some implementations, peer devices provide wireless connectively for communicating with one another.

Communication between devices in a wireless communication network may be subject to interference. For a communication from a first network device to a second network device, emissions of radio frequency (RF) energy by a nearby device may interfere with reception of signals at the second network device. For example, a Long Term Evolution (LTE) device operating in an unlicensed RF band that is also being used by a Wi-Fi device may experience significant interference from the Wi-Fi device, and/or can cause significant interference to the Wi-Fi device.

Because LTE and Wi-Fi devices operating in the same unlicensed RF band may interfere with each other, it may be desirable to develop mechanisms that enable these devices to operate more effectively while sharing the same unlicensed RF band.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an example, a method for processing signals from various radio access technologies (RATs) is provided. The method includes decoding, in a receiver configured for processing signals associated with a first RAT, a signal associated with a second RAT, wherein the signals associated with the first RAT and the signal associated with the second RAT are received over a communications medium using an unlicensed frequency spectrum. The method also includes identifying one or more characteristics of the decoded signal as a pilot or reference signal pattern in a waveform of the decoded signal, and determining the second RAT related to the decoded signal based at least in part on determining that the pilot or reference signal pattern in the waveform corresponds to the second RAT.

In another aspect, an apparatus for processing signals from various RATs is provided. The apparatus includes a signal decoding component configured to decode, in a receiver configured for processing signals associated with a first RAT, a signal associated with a second RAT, wherein the signals associated with the first RAT and the signal associated with the second RAT are received over a communications medium using an unlicensed frequency spectrum. The apparatus also includes a characteristics evaluating component configured to identify one or more characteristics of the decoded signal as a pilot or reference signal pattern in a waveform of the decoded signal, and a RAT determining component configured to determine the second RAT related to the decoded signal based at least in part on determining that the pilot or reference signal pattern in the waveform corresponds to the second RAT.

In yet another aspect, an apparatus for processing signals from various RATs is provided. The apparatus includes means for decoding, in a receiver configured for processing signals associated with a first RAT, a signal associated with a second RAT, wherein the signals associated with the first RAT and the signal associated with the second RAT are received over a communications medium using an unlicensed frequency spectrum. The apparatus further includes means for identifying one or more characteristics of the decoded signal as a pilot or reference signal pattern in a waveform of the decoded signal, and means for determining the second RAT related to the decoded signal based at least in part on determining that the pilot or reference signal pattern in the waveform corresponds to the second RAT.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a simplified block diagram of several sample aspects of a communication system employing co-located radios.

FIG. 2 shows a downlink frame structure used in Long Term Evolution (LTE).

FIG. 3 is a simplified block diagram of an example signal processing component for determining a RAT related to a decoded signal.

FIG. 4 is a flow diagram illustrating an example method of determining a radio access technology (RAT) related to a decoded signal based on characteristics thereof.

FIG. 5 is a simplified block diagram of several sample aspects of components that may be employed in communication nodes.

FIG. 6 is a simplified diagram of a wireless communication system.

FIG. 7 is a simplified diagram of a wireless communication system including small cells.

FIG. 8 is a simplified diagram illustrating coverage areas for wireless communication.

FIG. 9 is a simplified block diagram of several sample aspects of communication components.

FIG. 10 is a simplified block diagram of several sample aspects of apparatuses configured to support communication as taught herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

Described herein are various aspects related to distinguishing signals transmitted using different radio access technologies (RATs) over similar frequency and/or time resources. As such, in one configuration, an LTE small cell (SC) co-located with a Wi-Fi access point (AP) can provide communication in the same unlicensed frequency spectrum. The LTE SC and the Wi-Fi AP generally have separate integrated receivers to receive and process LTE and Wi-Fi packets. There may be instances where the Wi-Fi AP can be used to obtain (e.g., sniff or otherwise receive or detect) Wi-Fi signal information that can be provided to the LTE SC to coordinate the LTE communication schedule. In a similar example, the LTE SC can be used to obtain LTE signal information that can be provided to the Wi-Fi AP to improve Wi-Fi communications performance. LTE and Wi-Fi signals have distinguishing characteristics, however, and multiple receivers may not be needed to distinguish, properly receive, and process signals from LTE and Wi-Fi devices. Consequently, the disclosure describes various methods and apparatus for using a single receiver to differentiate between LTE and Wi-Fi signals based on distinguishing characteristics thereof.

Thus, according to an aspect described herein, signals transmitted using different radio access technologies (RATs) over similar unlicensed frequency and/or time resources can be distinguished based on characteristics specific to a given RAT. For example, a RAT can specify a certain cyclic prefix (CP)/guard interval (GI) structure to use in transmitting signals for the RAT, which can be determined and used to identify the signal as transmitted using the RAT. In another example, a RAT can utilize a certain pilot or reference signal pattern in transmitting signals for the RAT, which can be determined and used to identify the signal as transmitted using the RAT. Moreover, in an example, a RAT can specify a certain bandwidth to utilize in transmitting signals for the RAT, which can be determined and used to identify the signal as transmitted using the RAT. In yet another example, a RAT can specify a certain inter-packet spacing to use in transmitting signals for the RAT, which can be determined and used to identify the signal as transmitted using the RAT.

As used herein, the term “small cell” may refer to an access point or to a corresponding coverage area of the access point, where the access point in this case has a relatively low transmit power or relatively small coverage as compared to, for example, the transmit power or coverage area of a macro network access point or macro cell. For instance, a macro cell may cover a relatively large geographic area, such as, but not limited to, several kilometers in radius. In contrast, a small cell may cover a relatively small geographic area, such as, but not limited to, a home, a building, or a floor of a building. As such, a small cell may include, but is not limited to, an apparatus such as a base station (BS), an access point, a femto node, a femtocell, a pico node, a micro node, a Node B, evolved Node B (eNB), home Node B (HNB) or home evolved Node B (HeNB). Therefore, the term “small cell,” as used herein, refers to a relatively low transmit power and/or a relatively small coverage area cell as compared to a macro cell.

As used herein, the term “communications medium” can include substantially any wired or wireless medium over which one or more network nodes can communicate using a radio transceiver (e.g., transmitter and/or receiver) to send, receive, and process signals from one another. For example, a “communications medium” can include a radio frequency (RF) band, RF resources over one or more time periods, etc. Moreover, an “unlicensed” frequency band or spectrum, as used herein, can refer to a portion of RF space that is not licensed for use by one or more wireless wide area network (WWAN) technologies, but may or may not be used by other communication technologies (e.g., wireless local area network (WLAN) technologies, such as Wi-Fi). Moreover, a network or device that provides, adapts, or extends its operations for use in an “unlicensed” frequency band or spectrum may refer to a network or device that is configured to operate in a contention-based radio frequency band or spectrum.

Aspects of the disclosure are provided in the following description and related drawings directed to specific disclosed aspects. Alternate aspects may be devised without departing from the scope of the disclosure. Additionally, well-known aspects of the disclosure may not be described in detail or may be omitted so as not to obscure more relevant details. Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

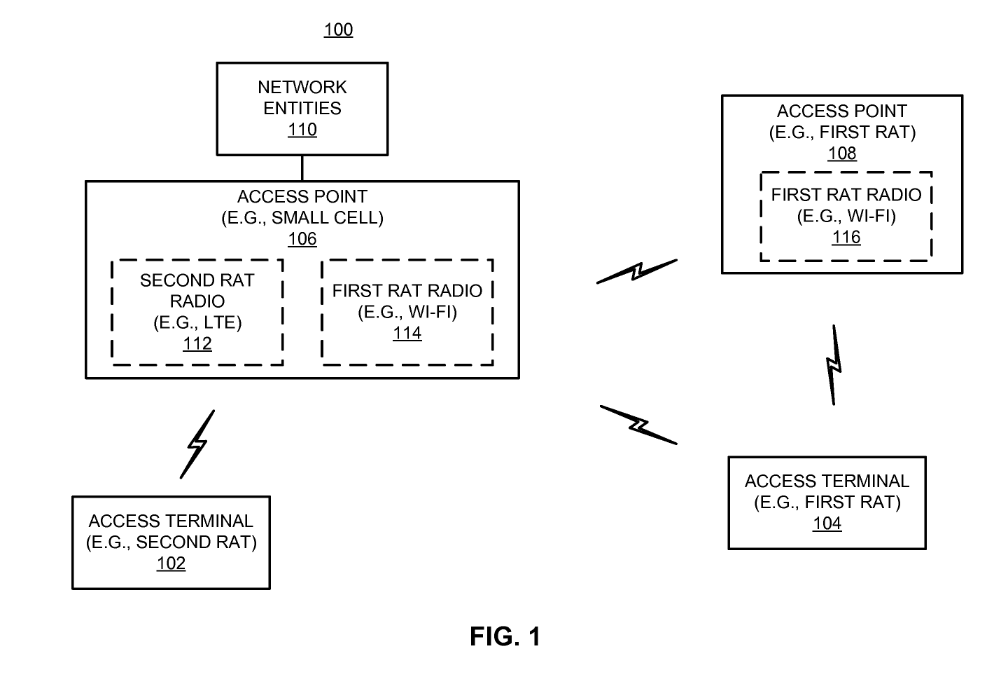

FIG. 1 illustrates several nodes of a sample communication system 100 (e.g., a portion of a communication network). For illustration purposes, various aspects of the disclosure will be described in the context of one or more access terminals, access points, and network entities that communicate with one another. It should be appreciated, however, that the teachings herein may be applicable to other types of apparatuses or other similar apparatuses that are referenced using other terminology. For example, in various implementations access points may be referred to or implemented as base stations, NodeBs, eNodeBs, Home NodeBs, Home eNodeBs, small cells, macro cells, femto cells, and so on, while access terminals may be referred to or implemented as user equipment (UEs), mobile stations, and so on.

Access points in the system 100 provide access to one or more services (e.g., network connectivity) for one or more wireless terminals (e.g., the access terminal 102 or the access terminal 104) that may be installed within or that may roam throughout a coverage area of the system 100. For example, at various points in time the access terminal 102 may connect to the access point 106 or some other access point in the system 100 (not shown). Similarly, the access terminal 104 may connect to the access point 108 or some other access point.

One or more of the access points may communicate with one or more network entities (represented, for convenience, by the network entities 110), including each other, to facilitate wide area network connectivity. Two or more of such network entities may be co-located and/or two or more of such network entities may be distributed throughout a network.

A network entity may take various forms such as, for example, one or more radio and/or core network entities. Thus, in various implementations the network entities 110 may represent functionality such as at least one of: network management (e.g., via an operation, administration, management, and provisioning entity), call control, session management, mobility management, gateway functions, interworking functions, or some other suitable network functionality. In some aspects, mobility management relates to: keeping track of the current location of access terminals through the use of tracking areas, location areas, routing areas, or some other suitable technique; controlling paging for access terminals; and providing access control for access terminals.

When the access point 106 (or any other devices in the system 100) uses a second RAT to communicate on a given resource or given medium, this communication may interfere with communications of nearby devices (e.g., the access point 108 and/or the access terminal 104) that use a first RAT to communicate on that resource or that medium. For example, communication by the access point 106 via LTE on a particular unlicensed RF band may interfere with communications of Wi-Fi devices operating on that band. For convenience, LTE on an unlicensed RF band may be referred to herein as LTE/LTE Advanced in unlicensed spectrum, or simply LTE in the surrounding context. When using LTE in an unlicensed frequency spectrum the access point 106 (or the access terminal 102) may be configured to access a specific network operating in a contention-based RF band or spectrum. In some aspects, one or more of the access points (e.g., access points 106, 108) in the system 100 may be configured to perform techniques described herein for differentiating between signals of different radio access technologies. For example, an access point that uses a first RAT radio may be configured to distinguish between first RAT signals and second RAT signals, such that the access point does not need a full second RAT radio but rather the first RAT radio can detect second RAT signals based on certain characteristics thereof, as described herein. Similarly an access point that uses a second RAT radio may be configured to distinguish between second RAT signals and first RAT signals without having a full first RAT radio.

In some systems, LTE in unlicensed spectrum may be employed in a standalone configuration, with all carriers operating exclusively in an unlicensed portion of the wireless spectrum (e.g., LTE Standalone). In other systems, LTE in unlicensed spectrum may be employed in a manner that is supplemental to licensed band operation by providing one or more unlicensed carriers operating in the unlicensed portion of the wireless spectrum in conjunction with an anchor licensed carrier operating in the licensed portion of the wireless spectrum (e.g., LTE Supplemental DownLink (SDL)). In either case, carrier aggregation may be employed to manage the different component carriers, with one carrier serving as the Primary Cell (PCell) for the corresponding UE (e.g., an anchor licensed carrier in LTE SDL or a designated one of the unlicensed carriers in LTE Standalone) and the remaining carriers serving as respective Secondary Cells (SCells). In this way, the PCell may provide an FDD paired downlink and uplink (licensed or unlicensed), and each SCell may provide additional downlink capacity as desired.

In general, LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz, and there may be 1, 2, 4, 8 or 16 subbands for system bandwidth of 1.25, 2.5, 5, 10 or 20 MHz, respectively.

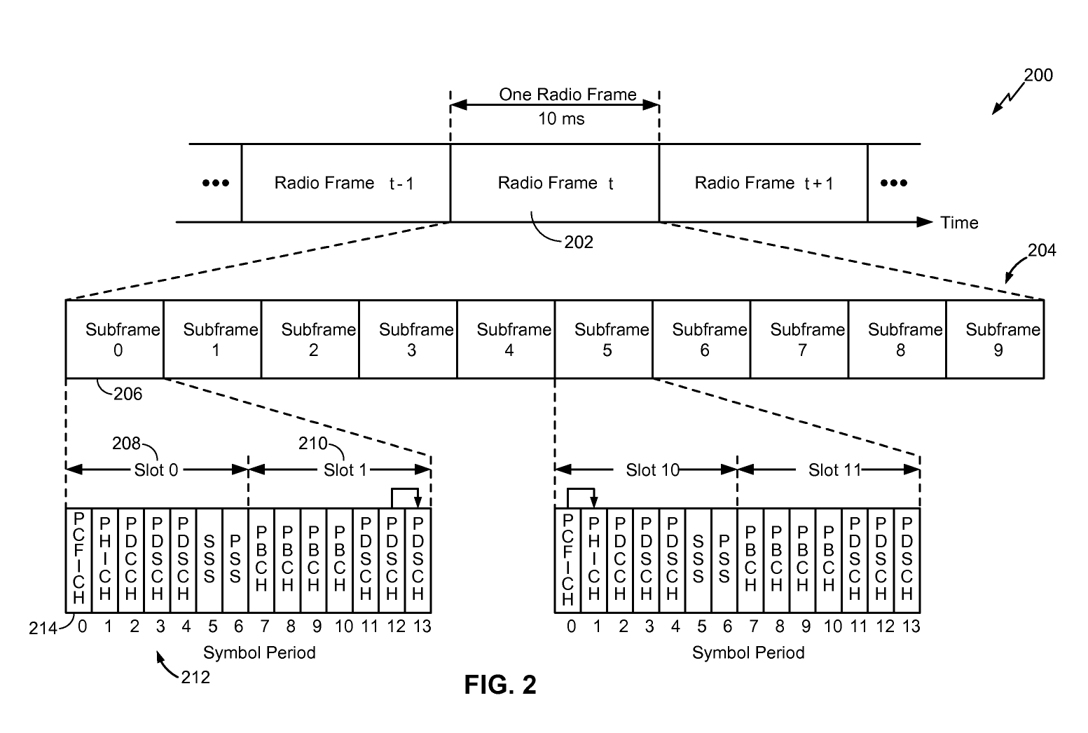

FIG. 2 shows a downlink frame structure 200 used in LTE. The transmission timeline for the downlink may be partitioned into units of radio frames 202, 204, 206. Each radio frame may have a predetermined duration (e.g., 10 milliseconds (ms)) and may be partitioned into 10 subframes 208 with indices of 0 through 9. Each subframe may include two slots, e.g., slots 210. Each radio frame may thus include 20 slots with indices of 0 through 19. Each slot may include L symbol periods, e.g., 7 symbol periods 212 for a normal cyclic prefix (CP), as shown in FIG. 2, or 6 symbol periods for an extended cyclic prefix. The normal CP and extended CP may be referred to herein as different CP types. The 2L symbol periods in each subframe may be assigned indices of 0 through 2L−1. The available time frequency resources may be partitioned into resource blocks. Each resource block may cover N subcarriers (e.g., 12 subcarriers) in one slot.

In LTE, the access point (referred to as an eNB) may send a Primary Synchronization Signal (PSS) and a Secondary Synchronization Signal (SSS) for each cell in the eNB. The primary and secondary synchronization signals may be sent in symbol periods 6 and 5, respectively, in each of subframes 0 and 5 of each radio frame with the normal cyclic prefix, as shown in FIG. 2. The synchronization signals may be used by the access terminals (referred to as UEs) for cell detection and acquisition. The eNB may send a Physical Broadcast Channel (PBCH) in symbol periods 0 to 3 in slot 1 of subframe 0. The PBCH may carry certain system information.

The eNB may send a Cell-specific Reference Signal (CRS) for each cell in the eNB. The CRS may be sent in symbols 0, 1, and 4 of each slot in case of the normal cyclic prefix, and in symbols 0, 1, and 3 of each slot in case of the extended cyclic prefix. The CRS may be used by UEs for coherent demodulation of physical channels, timing and frequency tracking, Radio Link Monitoring (RLM), Reference Signal Received Power (RSRP), and Reference Signal Received Quality (RSRQ) measurements, etc.

The eNB may send a Physical Control Format Indicator Channel (PCFICH) in only a portion of the first symbol period of each subframe, although depicted in the entire first symbol period in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 2, M=3. The eNB may send a Physical HARQ Indicator Channel (PHICH) and a Physical Downlink Control Channel (PDCCH) in the first M symbol periods of each subframe (M=3 in FIG. 2). The PHICH may carry information to support hybrid automatic retransmission (HARQ). The PDCCH may carry information on resource allocation for UEs and control information for downlink channels. Although not shown in the first symbol period in FIG. 2, it is understood that the PDCCH and PHICH may also be included in the first symbol period. Similarly, the PHICH and PDCCH may also both be in the second and third symbol periods, although not shown that way in FIG. 2. The eNB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNB may send the PSS, SSS and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search. A UE may be within the coverage of multiple eNBs. One of these eNBs may be selected to serve the UE. The serving eNB may be selected based on various criteria such as received power, path loss, signal-to-noise ratio (SNR), etc.

Returning to FIG. 1, the disclosure relates in some aspects to distinguishing signals between different technologies (e.g., different RATs) coexisting and operating on a commonly used resource (e.g., a particular unlicensed RF band or co-channel). The access point 106 may include one or more radios (e.g., transceivers) 112 or 114. The radio 112 uses a second RAT (e.g., LTE) to communicate. The radio 114 is capable of receiving signals using a first RAT (e.g., Wi-Fi). In addition, as described further herein, radio 112 can be additionally configured to detect signals of the first RAT, and/or radio 114 can be additionally configured to detect signals of the second RAT. This allows the radio 112 and/or 114 to perform various operations based on detecting signals of the other RAT, such as determine a level of utilization of wireless resources by the other RAT (e.g., medium utilization), perform channel selection based on the signals of the other RAT, and/or the like. Moreover, in an example, access point 108 can include a first RAT radio 116 for communicating using a first RAT (e.g., Wi-Fi).

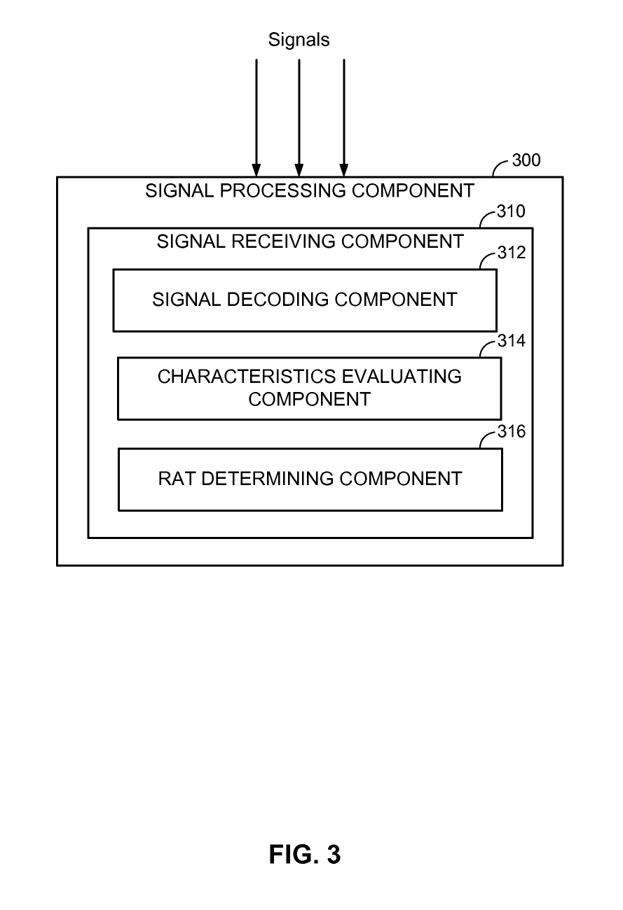

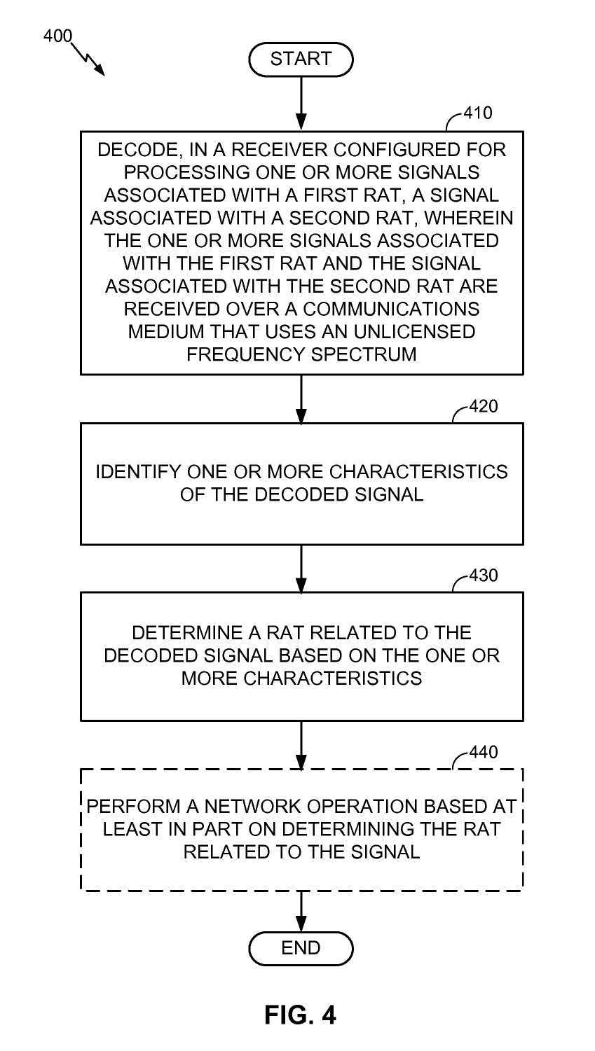

In one example, the radio 112 can receive signals from access terminal 102 and/or 104. Radio 112 may be or may include a signal processing component 300, signal receiving component 310, etc. (FIG. 3) that can analyze characteristics of the signals to determine whether the signals correspond to the first RAT or the second RAT, as described further herein in method 400 (FIG. 4). For example, the signals can have a CP/GI structure, pilot or reference signal pattern, bandwidth utilization, inter-packet spacing, etc. specific to the RAT. Using such characteristics to determine whether signals correlate to the first or second RAT can mitigate the need for a co-located radio or receiver chip to process signals of the other RAT. To this end, for example, access point 108 is also depicted with a single first RAT radio 116 that is capable of distinguishing LTE signals from Wi-Fi signals based on detected characteristics specific to LTE signals, thus mitigating the need for a co-located LTE radio.

Referring to FIGS. 3 and 4, aspects of the present apparatus and method are depicted with reference to one or more components and one or more methods that may perform the actions or functions described herein. Although the operations described below in FIG. 4 are presented in a particular order and/or as being performed by an example component, it should be understood that the ordering of the actions and the components performing the actions may be varied, depending on the implementation. Moreover, it should be understood that the following actions or functions may be performed by a specially-programmed processor, a processor executing specially-programmed software or computer-readable media, or by any other combination of a hardware component and/or a software component capable of performing the described actions or functions. Moreover, in an aspect, a component may be one of the parts that make up a system, may be hardware or software, and/or may be divided into other components.

FIG. 3 illustrates an example signal processing component 300 including a signal receiving component 310 for receiving and detecting signals of a second RAT based on characteristics thereof. For example, second RAT radio 112, first RAT radio 114, first RAT radio 116, etc., can be or can employ the signal processing component 300 for detecting signals of a different RAT, based on which a related access point 106 or 108 may perform a function or otherwise process the signal related to the different RAT.

FIG. 4 is a flow diagram illustrating an example method 400 of determining a RAT related to a signal received in an unlicensed frequency spectrum. The method may be performed by an access point (e.g., the small cell access point 106 illustrated in FIG. 1), which may have a radio that communicates with one or more access terminals using a first RAT, and is capable of detecting signals from one or more other RATs (e.g., a second RAT), such as by using a signal processing component 300 (FIG. 3). Moreover, it is to be appreciated that first and second RATs are referred to herein, and may include networks that respectively operate on first and second RATs, as described above.

Method 400 includes, at Block 410, decoding, in a receiver configured for processing one or more signals associated with a first RAT, a signal associated with a second RAT, wherein the one or more signals associated with the first RAT and the signal associated with the second RAT are received over a communications medium that uses an unlicensed frequency spectrum. As described, the method 400 can be performed by a receiver that receives and processes signals from a first RAT for communicating in a wireless network. For example, signal processing component 300 (FIG. 3) includes a signal receiving component 310 as the receiver that can receive and process one or more signals associated with the first RAT, and also may receive a signal associated with another RAT (e.g., the second RAT). The signal receiving component 310 can receive a signal at Block 410 to determine whether the signal relates to the first RAT or another RAT (e.g., a second RAT). For example, signal decoding component 312 can decode the signal as well (e.g., to receive an OFDM waveform related to the signal).

Method 400 also includes, at Block 420, identifying one or more characteristics of the decoded signal. Signal receiving component 310 can include a characteristics evaluating component 314 for determining and analyzing the one or more characteristics of the decoded signal. For example, characteristics evaluating component 314 can identify characteristics of the OFDM waveform decoded by signal decoding component 312 that can be specific to one or more RATs. For example, different RATs can define specific CP/GI structures, pilot pattern, reference signal transmission patterns, channel bandwidth allocations, inter-packet spacing structures, a combination thereof, etc., as described further below, and thus a receiver with knowledge of these characteristics can detect certain signal characteristics to identify a corresponding RAT.

Thus, method 400 also includes, at Block 430, determining a RAT related to the decoded signal based on the one or more characteristics. For example, signal processing component 300 can include a RAT determining component 316 for determining a RAT to which the signal relates based on the one or more characteristics. In an aspect, RAT determining component 316 compares the one or more characteristics determined by characteristics evaluating component 314 to values known for the characteristics for the second RAT (or first RAT/other RATs), and can accordingly determine whether the signal corresponds to the second RAT (or first RAT/other RATs). It is to be appreciated, for example, that characteristics evaluating component 314 can evaluate signal characteristics, and RAT determining component 316 may determine whether signal characteristics relate to the second RAT or other RATs in certain cases, such as where the signal cannot be processed or is otherwise not properly received (e.g., by the receiver/signal receiving component 310) and thus it may be assumed that the signal is of a RAT different from the first RAT.

For example, the first and second RATs can be a WLAN RAT, such as Wi-Fi, and a WWAN, such as LTE, respectively. Thus, where the signal receiving component 310 is a Wi-Fi radio/receiver, RAT determining component 316 can determine whether received signals are LTE signals or not based on aspects described herein. Where the signal receiving component 310 is an LTE radio/receiver, RAT determining component 316 can determine whether received signals are Wi-Fi signals or not based on aspects described herein. This mitigates the need to include two radios/receivers (e.g., one LTE and one Wi-Fi) in access points in either network.

In this example, the one or more characteristics of the decoded signal detected at Block 420 by characteristics evaluating component 314 can include a CP/GI structure of the OFDM waveform. For example, LTE and Wi-Fi both utilize OFDM and also both utilize CP/GI to facilitate improved channel estimation and/or to mitigate inter-symbol interference (e.g., inter-OFDM symbol interference). The CP/GI structure of LTE and Wi-Fi are distinct, and thus characteristics evaluating component 314 can determine the CP/GI or other frame structure characteristics of the signal decided by signal decoding component 312 to distinguish a Wi-Fi signal from an LTE signal.

For example, Wi-Fi signals can utilize a CP/GI structure of 800 nanoseconds (ns) every 4 microseconds (μs), referred to as long CP/GI, or 400 ns every 3.6 μs, referred to as short CP/GI. LTE signals can utilize a CP/GI structure of 4.7 μs or 5.2 μs is every 71.4 μs for normal CP, and/or 16.7 μs for extended CP every 83.4 μs. Accordingly, characteristics evaluating component 314 can use correlation to determine the CP/GI structure of the received signal as the one or more characteristics at Block 420. For example, the CP/GI structure can be determined at least in part by detecting similar subcarrier correlations in the related spans of time. Where the one or more characteristics of the signal indicate a CP/GI of 800 ns every 4 μs or 400 ns every 3.6 μs, RAT determining component 316 can determine, at Block 430, that the RAT related to the signal is Wi-Fi (e.g., where the signal receiving component 310 is an LTE radio or otherwise). Where the one or more characteristics of the signal indicate a CP/GI of 4.7 μs or 5.2 μs every 71.4 μs (or 16.7 μs every 83.4 μs), RAT determining component 316 can determine, at Block 430, that the RAT related to the signal is LTE (e.g., where the signal receiving component 310 is a Wi-Fi radio or otherwise).

In another example, the one or more characteristics of the decoded signal detected or identified by characteristics evaluating component 314 at Block 420 can include a pilot or reference signal pattern of the OFDM waveform. For example, LTE utilizes cell-specific reference signals (CRS) to facilitate channel estimation by a receiver of the CRS. LTE defines specific patterns for transmitting CRS over various subcarrier locations. Wi-Fi utilizes pilot signals transmitted according to fixed subcarrier locations, which may be specific to bandwidth utilized for the transmission. In either case, the CRS and pilot patterns are distinct characteristics of LTE and Wi-Fi signals, respectively, and can be utilized to distinguish a Wi-Fi signal from an LTE signal. Accordingly, characteristics evaluating component 314 can detect or identify a pattern of CRS or pilot tones in a decoded signal at the one or more characteristics at Block 420, and RAT determining component 316 can determine whether the tones are at fixed subcarrier locations within the signal (e.g., that correspond to Wi-Fi) and/or can compare a pattern of the tones (e.g., within subcarriers of the OFDM waveform) to known patterns (e.g., that correspond to LTE). Thus, RAT determining component 316 determines the RAT related to the signal at Block 430. For example, characteristics evaluating component 314 may detect or identify the CRS or pilot tones from the signal based on determining tones that have an energy level over a threshold (e.g., as compared to other subcarriers in the OFDM waveform or otherwise).

In yet another example, the one or more characteristics of the decoded signal detected at Block 420 can include a portion of bandwidth utilized by the OFDM waveform. For example, LTE and Wi-Fi can utilize distinct portions of bandwidth, which may be scaled based on a number of carriers. For example, Wi-Fi occupies approximately 17.5 MHz bandwidth, but can additionally bond channels to occupy 33.625 MHz, 76.625 MHz, or 151.25 MHz depending on a number of channels utilized. LTE occupies approximately 1.14 MHz, 2.7 MHz, 4.5 MHz, 9 MHz, 13.5 MHz, or 18 MHz depending on the bandwidth configuration per carrier. Additionally a maximum of up to five component carriers can be aggregated through LTE-Advanced Carrier Aggregation (CA) scheme, in some examples. As there is no overlap in the bandwidths, the characteristics evaluating component 314 can determine a portion of channel bandwidth that holds a majority of energy as the one or more characteristics at Block 420 (e.g., by comparing portions of the channel bandwidth with a threshold energy level). In this regard, RAT determining component 316 can determine whether the channel bandwidth corresponds to a possible bandwidth of Wi-Fi or LTE in determining the RAT for the signals (e.g., as LTE or Wi-Fi), at Block 430 by determining whether the portion of channel bandwidth holding the majority of energy achieves a bandwidth indicative of the RAT (e.g., 17.5 MHz, 33.625 MHz, 76.625 MHz, or 151.25 MHz of Wi-Fi, or 1.14 MHz, 2.7 MHz, 4.5 MHz, 9 MHz, 13.5 MHz, or 18 MHz of LTE).

In a further example, the one or more characteristics of the decoded signal detected by the characteristics evaluating component 314 at Block 420 can include an inter-packet spacing utilized in the OFDM waveform. For example, in LTE data is transmitted every 1 ms), if data is ready for transmission, whereas in Wi-Fi data is transmitted according to a distributed coordination function (DCF) procedure with inter-frame spacing (IFS). For example, a short inter-frame space (SIFS) (e.g., 16 μs for OFDM PHY), is usually indicative of a gap between data transmission and an acknowledgement. It is to be appreciated that the characteristics evaluating component 314 can detect or identify other IFS between received packets at Block 420 in this regard, such as DCF inter-frame space (DIFS) (e.g., SIFS+2*slot time=34 μs), reduced inter-frame space (RIFS) (e.g., 2 μs), point coordination function (PCF), PCF inter-frame space (PIFS) (e.g., SIFS+1*slot time=25 μs), extended inter-frame space (EIFS) (e.g., SIFS+ACK time+DIFS=94 μs), etc. In this example, the characteristics evaluating component 314 can determine an inter-packet spacing between two packets in the decoded signal as the one or more characteristics at Block 420. Thus, for example, RAT determining component 316 can determine whether the spacing corresponds to a given RAT (e.g., LTE spacing at 1 ms, Wi-Fi spacing indicating SIFS, DIFS, RIFS, PIFS, EIFS, etc.), and can accordingly determine the RAT related to the signal, at Block 430.

In another example, the one or more characteristics of the decoded signal detected by characteristics evaluating component 314 at Block 420 can include a preamble pattern of a packet. For example, in Wi-Fi, a preamble pattern can include short training fields (STF) and/or long training fields (LTF) that appear in the beginning of a packet/frame transmitted by one or more devices. Thus, characteristics evaluating component 314 can detect or identify the preamble as the one or more characteristics in Block 420. RAT determining component 316 can accordingly determine the RAT related to the signal as Wi-Fi at Block 430 where the preamble is of a pattern used for STFs or LTFs. It is to be appreciated that characteristics evaluating component 314 can determine one or more of the above characteristics (and/or other characteristics) for use by RAT determining component 316 in determining the RAT, for example

In any case, at Block 440, a network operation can be performed based at least in part on determining the RAT related to the signal. Thus, for example, where the RAT determining component 316 determines the signal is of another RAT (e.g., LTE, where the receiver is a Wi-Fi receiver, or Wi-Fi, where the receiver is an LTE receiver), the network operation performed at Block 440 may include determining a medium utilization of the other RAT, selecting a channel (or other time/frequency resources) for communicating using the current RAT (e.g., to avoid interference with the other RAT), canceling the signal to mitigate interference caused by the signal of the other RAT to signals of the first RAT, and/or the like. This network operation can be performed, for example, by a signal receiving component 310, the signal processing component 300, a device employing the signal processing component 300 or signal receiving component 310 (e.g., one or more access points, etc.), and/or the like.

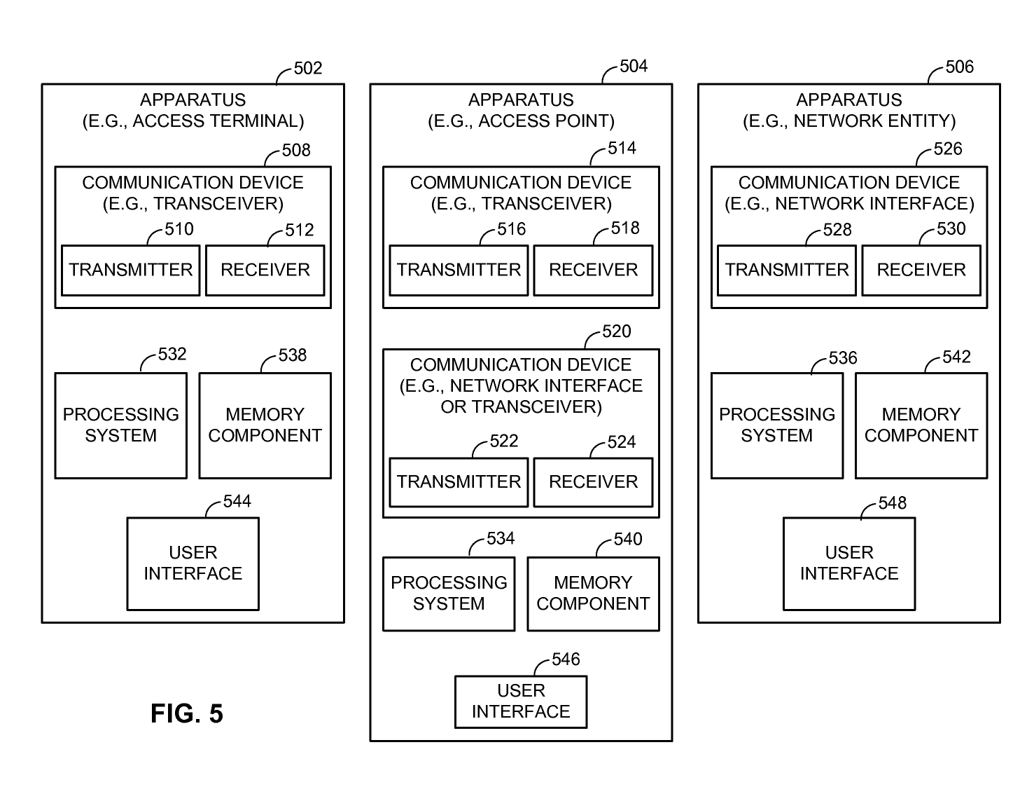

FIG. 5 illustrates several sample components (represented by corresponding blocks) that may be incorporated into an apparatus 502, an apparatus 504, and an apparatus 506 (e.g., corresponding to an access terminal, an access point, and a network entity, respectively) to support signal processing operations as taught herein. It should be appreciated that these components may be implemented in different types of apparatuses in different implementations (e.g., in an ASIC, in an SoC, etc.). The described components also may be incorporated into other apparatuses in a communication system. For example, other apparatuses in a system may include components similar to those described to provide similar functionality. Also, a given apparatus may contain one or more of the described components. For example, an apparatus may include one of a plurality of transceiver components that enable the apparatus to receive signals of one or more RATs, operate on multiple carriers, and/or communicate via different technologies. In an example, apparatus 502 can include an access terminal 102, 104, apparatus 504 can include an access point 106, 108, apparatus 506 can include network entities 110, etc.

The apparatus 502 and the apparatus 504 each include at least one wireless communication device (represented by the communication devices 508 and 514 (and the communication device 520 if the apparatus 504 is a relay)) for communicating with other nodes via at least one designated radio access technology. Each communication device 508 includes at least one transmitter (represented by the transmitter 510) for transmitting and encoding signals (e.g., messages, indications, information, and so on) and at least one receiver (represented by the receiver 512) for receiving and decoding signals (e.g., messages, indications, information, pilots, and so on). Similarly, each communication device 514 includes at least one transmitter (represented by the transmitter 516) for transmitting signals (e.g., messages, indications, information, pilots, and so on) and at least one receiver (represented by the receiver 518) for receiving signals (e.g., messages, indications, information, and so on). In an example, receiver 518, or other receivers depicted in FIG. 5, can include a signal processing component 300, signal receiving component 310, components thereof, etc. (FIG. 3) for performing aspects of method 400 (FIG. 4), described herein. If the apparatus 504 is a relay access point, each communication device 520 may include at least one transmitter (represented by the transmitter 522) for transmitting signals (e.g., messages, indications, information, pilots, and so on) and at least one receiver (represented by the receiver 524) for receiving signals (e.g., messages, indications, information, and so on).

A transmitter and a receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. In some aspects, a wireless communication device (e.g., one of multiple wireless communication devices) of the apparatus 504 comprises a network listen module.

The apparatus 506 (and the apparatus 504 if it is not a relay access point) includes at least one communication device (represented by the communication device 526 and, optionally, 520) for communicating with other nodes. For example, the communication device 526 may comprise a network interface that is configured to communicate with one or more network entities via a wire-based or wireless backhaul. In some aspects, the communication device 526 may be implemented as a transceiver configured to support wire-based or wireless signal communication. This communication may involve, for example, sending and receiving: messages, parameters, or other types of information. Accordingly, in the example of FIG. 5, the communication device 526 is shown as comprising a transmitter 528 and a receiver 530. Similarly, if the apparatus 504 is not a relay access point, the communication device 520 may comprise a network interface that is configured to communicate with one or more network entities via a wire-based or wireless backhaul. As with the communication device 526, the communication device 520 is shown as comprising a transmitter 522 and a receiver 524.

The apparatuses 502, 504, and 506 also include other components that may be used in conjunction with signal processing operations as taught herein. The apparatus 502 includes a processing system 532 for providing functionality relating to, for example, communicating with an access point to support communication adaptation as taught herein and for providing other processing functionality. The apparatus 504 includes a processing system 534 for providing functionality relating to, for example, communication adaptation as taught herein and for providing other processing functionality. The apparatus 506 includes a processing system 536 for providing functionality relating to, for example, communication adaptation as taught herein and for providing other processing functionality. The apparatuses 502, 504, and 506 include memory devices 538, 540, and 542 (e.g., each including a memory device), respectively, for maintaining information (e.g., information indicative of reserved resources, thresholds, parameters, and so on). In addition, the apparatuses 502, 504, and 506 include user interface devices 544, 546, and 548, respectively, for providing indications (e.g., audible and/or visual indications) to a user and/or for receiving user input (e.g., upon user actuation of a sensing device such a keypad, a touch screen, a microphone, and so on).

For convenience, the apparatus 502 is shown in FIG. 5 as including components that may be used in the various examples described herein. In practice, the illustrated blocks may have different functionality in different aspects.

The components of FIG. 5 may be implemented in various ways. In some implementations, the components of FIG. 5 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 508, 532, 538, and 544 may be implemented by processor and memory component(s) of the apparatus 502 (e.g., by execution of appropriate code and/or by appropriate configuration of processor components). Similarly, some or all of the functionality represented by blocks 514, 520, 534, 540, and 546 may be implemented by processor and memory component(s) of the apparatus 504 (e.g., by execution of appropriate code and/or by appropriate configuration of processor components). Also, some or all of the functionality represented by blocks 526, 536, 542, and 548 may be implemented by processor and memory component(s) of the apparatus 506 (e.g., by execution of appropriate code and/or by appropriate configuration of processor components).

Some of the access points referred to herein may comprise low-power access points. In a typical network, low-power access points (e.g., femto cells) are deployed to supplement conventional network access points (e.g., macro access points). For example, a low-power access point installed in a user's home or in an enterprise environment (e.g., commercial buildings) may provide voice and high speed data service for access terminals supporting cellular radio communication (e.g., CDMA, WCDMA, UMTS, LTE, etc.). In general, these low-power access points provide more robust coverage and higher throughput for access terminals in the vicinity of the low-power access points.

As used herein, the term low-power access point refers to an access point having a transmit power (e.g., one or more of: maximum transmit power, instantaneous transmit power, nominal transmit power, average transmit power, or some other form of transmit power) that is less than a transmit power (e.g., as defined above) of any macro access point in the coverage area. In some implementations, each low-power access point has a transmit power (e.g., as defined above) that is less than a transmit power (e.g., as defined above) of the macro access point by a relative margin (e.g., 10 dBm or more). In some implementations, low-power access points such as femto cells may have a maximum transmit power of 20 dBm or less. In some implementations, low-power access points such as pico cells may have a maximum transmit power of 24 dBm or less. It should be appreciated, however, that these or other types of low-power access points may have a higher or lower maximum transmit power in other implementations (e.g., up to 1 Watt in some cases, up to 10 Watts in some cases, and so on).

Typically, low-power access points connect to the Internet via a broadband connection (e.g., a digital subscriber line (DSL) router, a cable modem, or some other type of modem) that provides a backhaul link to a mobile operator's network. Thus, a low-power access point deployed in a user's home or business provides mobile network access to one or more devices via the broadband connection.

Various types of low-power access points may be employed in a given system. For example, low-power access points may be implemented as or referred to as femto cells, femto access points, small cells, femto nodes, home NodeBs (HNBs), home eNodeBs (HeNBs), access point base stations, pico cells, pico nodes, or micro cells.

For convenience, low-power access points may be referred to simply as small cells in the discussion that follows. Thus, it should be appreciated that any discussion related to small cells herein may be equally applicable to low-power access points in general (e.g., to femto cells, to micro cells, to pico cells, etc.).

Small cells may be configured to support different types of access modes. For example, in an open access mode, a small cell may allow any access terminal to obtain any type of service via the small cell. In a restricted (or closed) access mode, a small cell may only allow authorized access terminals to obtain service via the small cell. For example, a small cell may only allow access terminals (e.g., so called home access terminals) belonging to a certain subscriber group (e.g., a closed subscriber group (CSG)) to obtain service via the small cell. In a hybrid access mode, alien access terminals (e.g., non-home access terminals, non-CSG access terminals) may be given limited access to the small cell. For example, a macro access terminal that does not belong to a small cell's CSG may be allowed to access the small cell only if sufficient resources are available for all home access terminals currently being served by the small cell.

Thus, small cells operating in one or more of these access modes may be used to provide indoor coverage and/or extended outdoor coverage. By allowing access to users through adoption of a desired access mode of operation, small cells may provide improved service within the coverage area and potentially extend the service coverage area for users of a macro network.

Thus, in some aspects the teachings herein may be employed in a network that includes macro scale coverage (e.g., a large area cellular network such as a third generation (3G) network, typically referred to as a macro cell network or a WAN) and smaller scale coverage (e.g., a residence-based or building-based network environment, typically referred to as a LAN). As an access terminal (AT) moves through such a network, the access terminal may be served in certain locations by access points that provide macro coverage while the access terminal may be served at other locations by access points that provide smaller scale coverage. In some aspects, the smaller coverage nodes may be used to provide incremental capacity growth, in-building coverage, and different services (e.g., for a more robust user experience).

In the description herein, a node (e.g., an access point) that provides coverage over a relatively large area may be referred to as a macro access point while a node that provides coverage over a relatively small area (e.g., a residence) may be referred to as a small cell. It should be appreciated that the teachings herein may be applicable to nodes associated with other types of coverage areas. For example, a pico access point may provide coverage (e.g., coverage within a commercial building) over an area that is smaller than a macro area and larger than a femto cell area. In various applications, other terminology may be used to reference a macro access point, a small cell, or other access point-type nodes. For example, a macro access point may be configured or referred to as an access node, base station, access point, eNodeB, macro cell, and so on. In some implementations, a node may be associated with (e.g., referred to as or divided into) one or more cells or sectors. A cell or sector associated with a macro access point, a femto access point, or a pico access point may be referred to as a macro cell, a femto cell, or a pico cell, respectively.

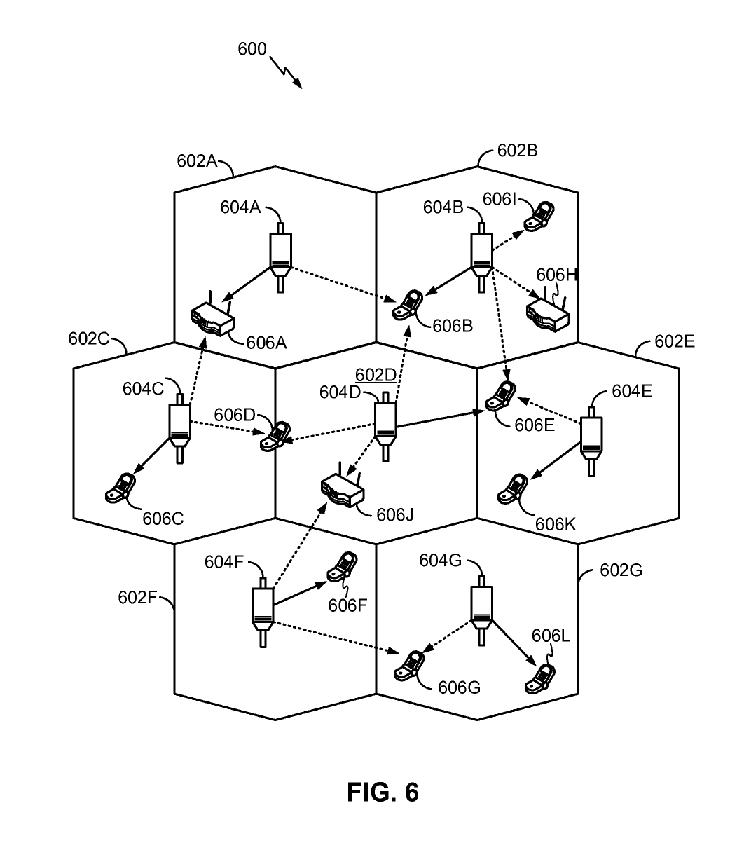

FIG. 6 illustrates a wireless communication system 600, configured to support a number of users, in which the teachings herein may be implemented. The system 600 provides communication for multiple cells 602, such as, for example, macro cells 602A-602G, with each cell being serviced by a corresponding access point 604 (e.g., access points 604A-604G). As shown in FIG. 6, access terminals 606 (e.g., access terminals 606A-606L) may be dispersed at various locations throughout the system over time. Each access terminal 606 may communicate with one or more access points 604 on a forward link (FL) and/or a reverse link (RL) at a given moment, depending upon whether the access terminal 606 is active and whether it is in soft handoff, for example. The wireless communication system 600 may provide service over a large geographic region. For example, macro cells 602A-602G may cover a few blocks in a neighborhood or several miles in a rural environment. In an example, access points 604 can include an access point 106, 108, access terminals 606 can include an access terminal 102, 104, etc., and thus, access points 604 and/or access terminals 606 may include a signal processing component 300, signal receiving component 310, components thereof, etc. (FIG. 3) for performing method 400 (FIG. 4).

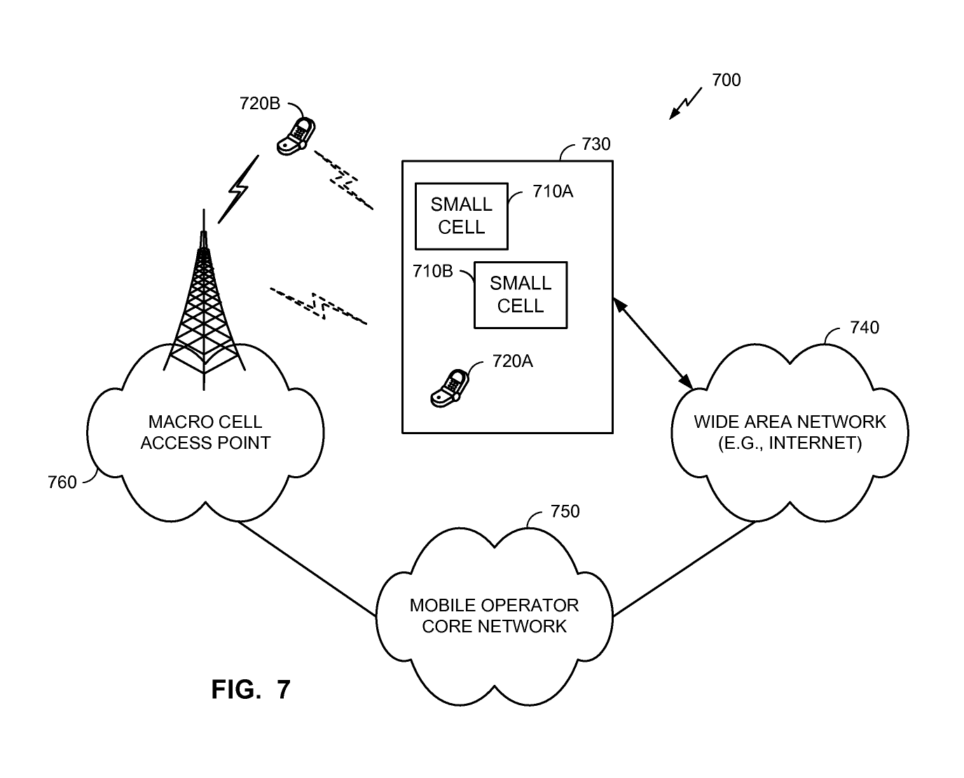

FIG. 7 illustrates an example of a communication system 700 where one or more small cells are deployed within a network environment. Specifically, the system 700 includes multiple small cells 710 (e.g., small cells 710A and 710B) installed in a relatively small scale network environment (e.g., in one or more user residences 730). Each small cell 710 may be coupled to a wide area network 740 (e.g., the Internet) and a mobile operator core network 750 via a DSL router, a cable modem, a wireless link, or other connectivity means (not shown). As will be discussed below, each small cell 710 may be configured to serve associated access terminals 720 (e.g., access terminal 720A) and, optionally, other (e.g., hybrid or alien) access terminals 720 (e.g., access terminal 720B). In other words, access to small cells 710 may be restricted whereby a given access terminal 720 may be served by a set of designated (e.g., home) small cell(s) 710 but may not be served by any non-designated small cells 710 (e.g., a neighbor's small cell 710). In an example, small cells 710 and/or macro cell access point 706 can include an access point 106, 108, access terminals 720 can include an access terminal 102, 104, etc., and thus, small cells 710, macro cell access point 706, access terminals 720, etc. may include a signal processing component 300, signal receiving component 310, components thereof, etc. (FIG. 3) for performing method 400 (FIG. 4).

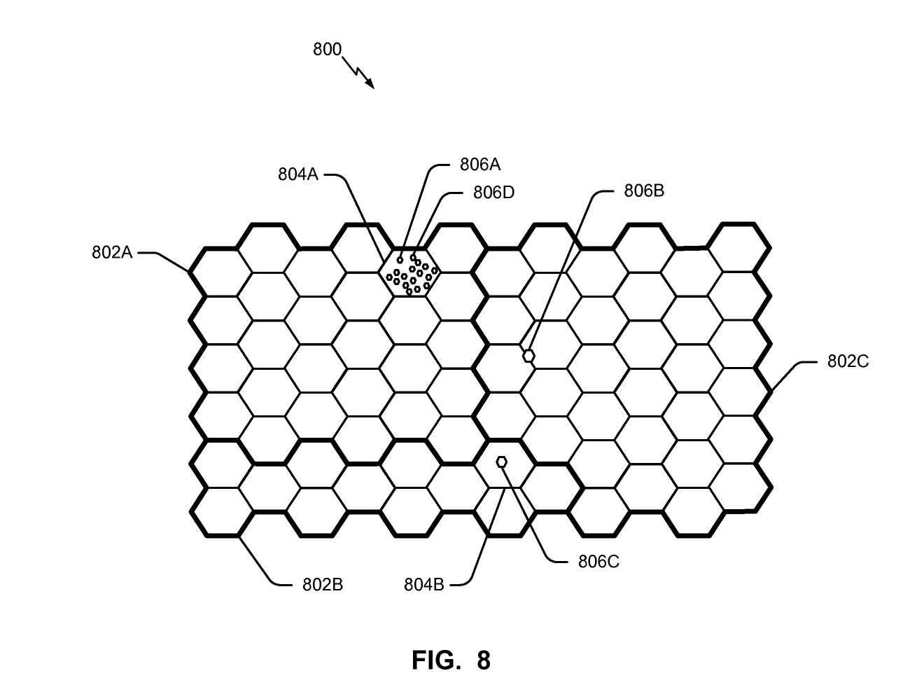

FIG. 8 illustrates an example of a coverage map 800 where several tracking areas 802 (or routing areas or location areas) are defined, each of which includes several macro coverage areas 804. Here, areas of coverage associated with tracking areas 802A, 802B, and 802C are delineated by the wide lines and the macro coverage areas 804 are represented by the larger hexagons. The tracking areas 802 also include femto coverage areas 806. In this example, each of the femto coverage areas 806 (e.g., femto coverage areas 806B and 806C) is depicted within one or more macro coverage areas 804 (e.g., macro coverage areas 804A and 804B). It should be appreciated, however, that some or all of a femto coverage area 806 might not lie within a macro coverage area 804. In practice, a large number of femto coverage areas 806 (e.g., femto coverage areas 806A and 806D) may be defined within a given tracking area 802 or macro coverage area 804. Also, one or more pico coverage areas (not shown) may be defined within a given tracking area 802 or macro coverage area 804. Moreover, in an example, the various coverage areas 802, 804, 806 of FIG. 8 may relate to coverage areas provided for the first and second RATs in FIG. 1.

Referring again to FIG. 7, the owner of a small cell 710 may subscribe to mobile service, such as, for example, 3G mobile service, offered through the mobile operator core network 750. In addition, an access terminal 720 may be capable of operating both in macro environments and in smaller scale (e.g., residential) network environments. In other words, depending on the current location of the access terminal 720, the access terminal 720 may be served by a macro cell access point 760 associated with the mobile operator core network 750 or by any one of a set of small cells 710 (e.g., the small cells 710A and 710B that reside within a corresponding user residence 730). For example, when a subscriber is outside his home, he is served by a standard macro access point (e.g., access point 760) and when the subscriber is at home, he is served by a small cell (e.g., small cell 710A). Here, a small cell 710 may be backward compatible with legacy access terminals 720.

A small cell 710 may be deployed on a single frequency or, in the alternative, on multiple frequencies. Depending on the particular configuration, the single frequency or one or more of the multiple frequencies may overlap with one or more frequencies used by a macro access point (e.g., access point 760).

In some aspects, an access terminal 720 may be configured to connect to a preferred small cell (e.g., the home small cell of the access terminal 720) whenever such connectivity is possible. For example, whenever the access terminal 720A is within the user's residence 730, it may be desired that the access terminal 720A communicate only with the home small cell 710A or 710B.

In some aspects, if the access terminal 720 operates within the macro cellular network 750 but is not residing on its most preferred network (e.g., as defined in a preferred roaming list), the access terminal 720 may continue to search for the most preferred network (e.g., the preferred small cell 710) using a better system reselection (BSR) procedure, which may involve a periodic scanning of available systems to determine whether better systems are currently available and subsequently acquire such preferred systems. The access terminal 720 may limit the search for specific band and channel. For example, one or more femto channels may be defined whereby all small cells (or all restricted small cells) in a region operate on the femto channel(s). The search for the most preferred system may be repeated periodically. Upon discovery of a preferred small cell 710, the access terminal 720 selects the small cell 710 and registers on it for use when within its coverage area.

Access to a small cell may be restricted in some aspects. For example, a given small cell may only provide certain services to certain access terminals. In deployments with so-called restricted (or closed) access, a given access terminal may only be served by the macro cell mobile network and a defined set of small cells (e.g., the small cells 710 that reside within the corresponding user residence 730). In some implementations, an access point may be restricted to not provide, for at least one node (e.g., access terminal), at least one of: signaling, data access, registration, paging, or service.

In some aspects, a restricted small cell (which may also be referred to as a Closed Subscriber Group Home NodeB) is one that provides service to a restricted provisioned set of access terminals. This set may be temporarily or permanently extended as necessary. In some aspects, a Closed Subscriber Group (CSG) may be defined as the set of access points (e.g., small cells) that share a common access control list of access terminals.

Various relationships may thus exist between a given small cell and a given access terminal. For example, from the perspective of an access terminal, an open small cell may refer to a small cell with unrestricted access (e.g., the small cell allows access to any access terminal). A restricted small cell may refer to a small cell that is restricted in some manner (e.g., restricted for access and/or registration). A home small cell may refer to a small cell on which the access terminal is authorized to access and operate on (e.g., permanent access is provided for a defined set of one or more access terminals). A hybrid (or guest) small cell may refer to a small cell on which different access terminals are provided different levels of service (e.g., some access terminals may be allowed partial and/or temporary access while other access terminals may be allowed full access). An alien small cell may refer to a small cell on which the access terminal is not authorized to access or operate on, except for perhaps emergency situations (e.g., emergency-911 calls).

From a restricted small cell perspective, a home access terminal may refer to an access terminal that is authorized to access the restricted small cell installed in the residence of that access terminal's owner (usually the home access terminal has permanent access to that small cell). A guest access terminal may refer to an access terminal with temporary access to the restricted small cell (e.g., limited based on deadline, time of use, bytes, connection count, or some other criterion or criteria). An alien access terminal may refer to an access terminal that does not have permission to access the restricted small cell, except for perhaps emergency situations, for example, such as 911 calls (e.g., an access terminal that does not have the credentials or permission to register with the restricted small cell).

For convenience, the disclosure herein describes various functionality in the context of a small cell. It should be appreciated, however, that a pico access point may provide the same or similar functionality for a larger coverage area. For example, a pico access point may be restricted, a home pico access point may be defined for a given access terminal, and so on.

The teachings herein may be employed in a wireless multiple-access communication system that simultaneously supports communication for multiple wireless access terminals. Here, each terminal may communicate with one or more access points via transmissions on the forward and reverse links. The forward link (or downlink) refers to the communication link from the access points to the terminals, and the reverse link (or uplink) refers to the communication link from the terminals to the access points. This communication link may be established via a single-in-single-out system, a multiple-in-multiple-out (MIMO) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min {N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (TDD) and frequency division duplex (FDD). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

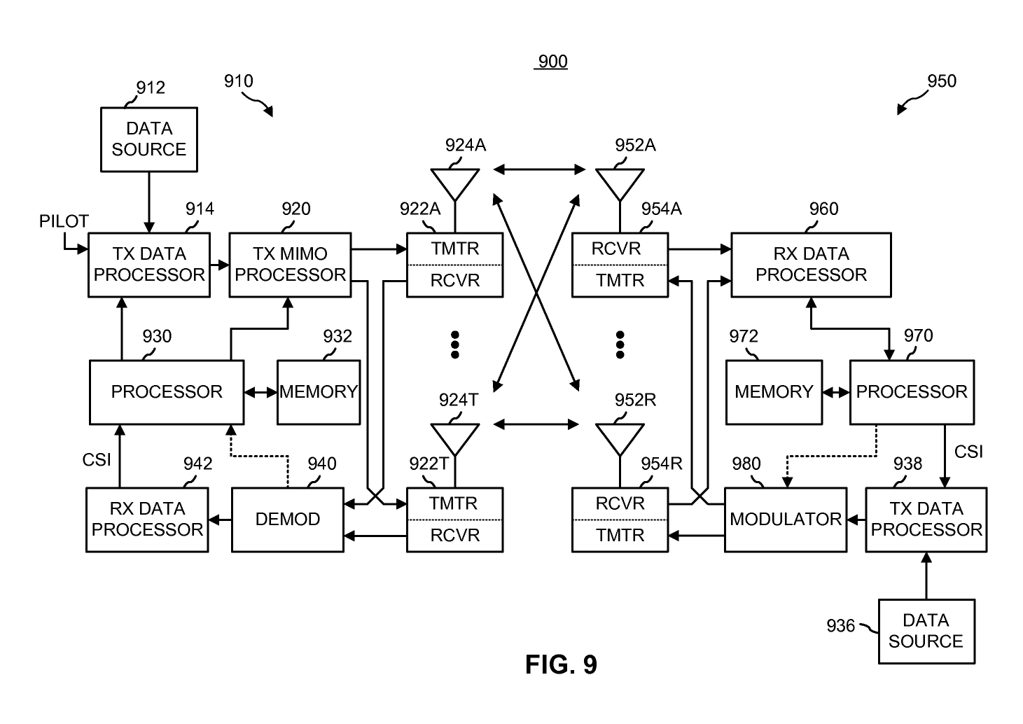

FIG. 9 illustrates in more detail the components of a wireless device 910 (e.g., a small cell AP) and a wireless device 950 (e.g., a UE) of a sample communication system 900 that may be adapted as described herein. In an example, wireless device 910 can include an access point 106, 108, wireless device 950 can include an access terminal 102, 104, etc., and thus, wireless devices 910, 950 may include a signal processing component 300, signal receiving component 310, components thereof, etc. (FIG. 3) for performing method 400 (FIG. 4). At the device 910, traffic data for a number of data streams is provided from a data source 912 to a transmit (TX) data processor 914. Each data stream may then be transmitted over a respective transmit antenna.

The TX data processor 914 formats, codes, and interleaves the traffic data for each data stream based on a particular coding scheme selected for that data stream to provide coded data. The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 930. A data memory 932 may store program code, data, and other information used by the processor 930 or other components of the device 910.

The modulation symbols for all data streams are then provided to a TX MIMO processor 920, which may further process the modulation symbols (e.g., for OFDM). The TX MIMO processor 920 then provides NT modulation symbol streams to NT transceivers (XCVR) 922A through 922T. In some aspects, the TX MIMO processor 920 applies beam-forming weights to the symbols of the data streams and to the antenna from which the symbol is being transmitted.

Each transceiver 922 receives and processes a respective symbol stream to provide one or more analog signals, and further conditions (e.g., amplifies, filters, and upconverts) the analog signals to provide a modulated signal suitable for transmission over the MIMO channel. NT modulated signals from transceivers 922A through 922T are then transmitted from NT antennas 924A through 924T, respectively. For example, transceivers 922A through 922T, or related receiver portions, can implement the process described in method 400 above.

At the device 950, the transmitted modulated signals are received by NR antennas 952A through 952R and the received signal from each antenna 952 is provided to a respective transceiver (XCVR) 954A through 954R. Each transceiver 954 conditions (e.g., filters, amplifies, and downconverts) a respective received signal, digitizes the conditioned signal to provide samples, and further processes the samples to provide a corresponding “received” symbol stream.

A receive (RX) data processor 960 then receives and processes the NR received symbol streams from NR transceivers 954 based on a particular receiver processing technique to provide NT “detected” symbol streams. The RX data processor 960 then demodulates, deinterleaves, and decodes each detected symbol stream to recover the traffic data for the data stream. The processing by the RX data processor 960 is complementary to that performed by the TX MIMO processor 920 and the TX data processor 914 at the device 910.

A processor 970 periodically determines which pre-coding matrix to use (discussed below). The processor 970 formulates a reverse link message comprising a matrix index portion and a rank value portion. A data memory 972 may store program code, data, and other information used by the processor 970 or other components of the device 950.

The reverse link message may comprise various types of information regarding the communication link and/or the received data stream. The reverse link message is then processed by a TX data processor 938, which also receives traffic data for a number of data streams from a data source 936, modulated by a modulator 980, conditioned by the transceivers 954A through 954R, and transmitted back to the device 910.

At the device 910, the modulated signals from the device 950 are received by the antennas 924, conditioned by the transceivers 922, demodulated by a demodulator (DEMOD) 940, and processed by a RX data processor 942 to extract the reverse link message transmitted by the device 950. The processor 930 then determines which pre-coding matrix to use for determining the beam-forming weights then processes the extracted message.

It will be appreciated that for each device 910 and 950 the functionality of two or more of the described components may be provided by a single component. It will be also be appreciated that the various communication components illustrated in FIG. 9 and described above may be further configured as appropriate to perform communication adaptation as taught herein. For example, the processors 930/970 may cooperate with the memories 932/972 and/or other components of the respective devices 910/950 to perform the communication adaptation as taught herein.

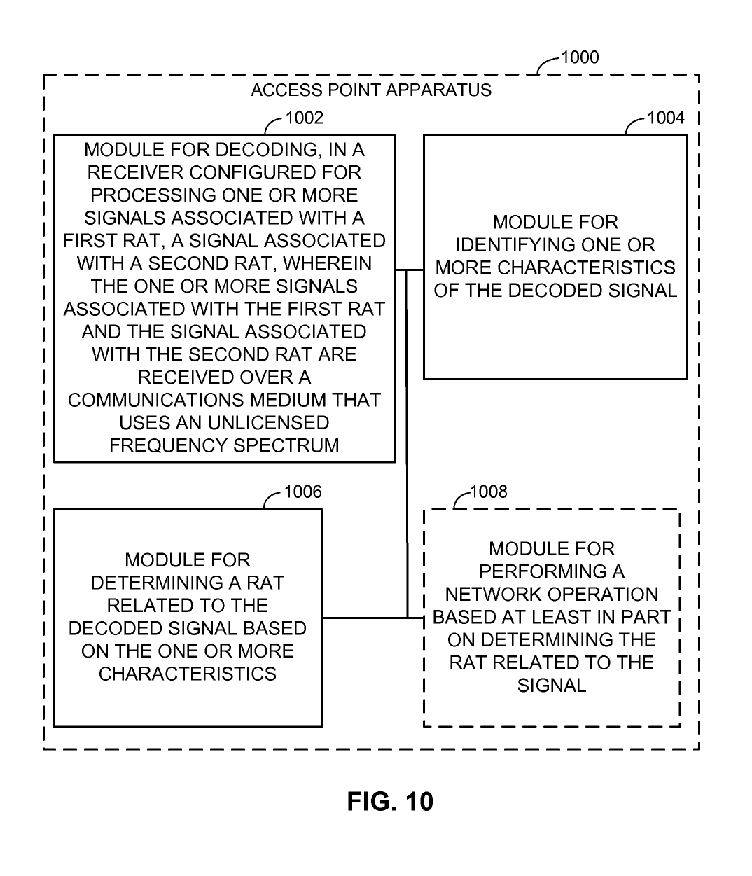

FIG. 10 illustrates an example access point apparatus 1000 represented as a series of interrelated functional modules. A module for decoding, in a receiver configured for processing one or more signals associated with a first RAT, a signal associated with a second RAT, wherein the one or more signals associated with the first RAT and the signal associated with the second RAT are received over a communications medium that uses an unlicensed frequency spectrum 1002 may correspond at least in some aspects to, for example, a processing system or communication device (e.g., a receiver, transceiver, etc.), as discussed herein. A module for detecting one or more characteristics of the decoded signal 1004 may correspond at least in some aspects to, for example, a processing system or communication device (e.g., a receiver, transceiver, etc.), as discussed herein. A module for determining a RAT related to the decoded signal based on the one or more characteristics 1006 may correspond at least in some aspects to, for example, a processing system or communication device (e.g., a receiver, transceiver, etc.), as discussed herein. A module for performing a network operation based at least in part on determining the RAT related to the signal 1008 may correspond at least in some aspects to, for example, a processing system or communication device (e.g., a receiver, transceiver, etc.), as discussed herein

The functionality of the modules of FIG. 10 may be implemented in various ways consistent with the teachings herein. In some aspects, the functionality of these modules may be implemented as one or more electrical components. In some aspects, the functionality of these blocks may be implemented as a processing system including one or more processor components. In some aspects, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module.

In addition, the components and functions represented by FIG. 10 as well as other components and functions described herein, may be implemented using any suitable means. Such means also may be implemented, at least in part, using corresponding structure as taught herein. For example, the components described above in conjunction with the “module for” components of FIG. 10 also may correspond to similarly designated “means for” functionality. Thus, in some aspects one or more of such means may be implemented using one or more of processor components, integrated circuits, or other suitable structure as taught herein.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor.

Accordingly, an aspect of the disclosure can include a computer readable medium embodying a method as described herein for processing signals from various radio access technologies. Accordingly, the disclosure is not limited to the illustrated examples.

While the foregoing disclosure shows illustrative aspects, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method for processing signals from various radio access technologies (RATs), comprising:
decoding, in a receiver configured for processing one or more signals associated with a first RAT, a signal associated with a second RAT, wherein the one or more signals associated with the first RAT and the signal associated with the second RAT are received over a communications medium that uses an unlicensed frequency spectrum;
identifying one or more characteristics in a waveform of the decoded signal as at least one of a pilot pattern, a reference signal pattern, or a combination thereof; and
determining that a RAT related to the decoded signal is the second RAT based at least in part on determining that at least one of the pilot pattern, the reference signal pattern, or the combination thereof, corresponds to the second RAT.

2. The method of claim 1, wherein the second RAT is a wireless local area network (WLAN) RAT, and the determining that the RAT is the second RAT comprises determining that at least one of the pilot pattern, the reference signal pattern, or the combination thereof, includes one or more pilot tones at fixed subcarrier locations within the waveform.

3. The method of claim 1, wherein the second RAT is a wireless wide area network (WWAN) RAT, and the determining that the RAT is the second RAT comprises determining that at least one of the pilot pattern, the reference signal pattern, or the combination thereof, includes pilot tones at subcarrier locations within the waveform corresponding to a cell-specific reference signal (CRS) pattern.

4. The method of claim 1, wherein the identifying the one or more characteristics further comprises detecting an inter-packet spacing in the waveform of the decoded signal, and wherein the determining that the RAT is the second RAT is further based at least in part on determining that the inter-packet spacing of the waveform corresponds to the second RAT.

5. The method of claim 4, wherein the second RAT is a WLAN RAT, and the inter-packet spacing of the waveform comprises an inter-frame space (IFS) associated with the WLAN RAT.

6. The method of claim 1, wherein the identifying the one or more characteristics further comprises detecting a preamble pattern comprising at least one of short training fields, long training fields, or a combination thereof, and wherein the determining that the RAT is the second RAT is further based at least in part on detecting the preamble pattern.

7. The method of claim 1, further comprising performing, based at least in part on determining that the RAT is the second RAT, at least one of determining of a level of utilization of the communications medium by the second RAT, determining of a channel selection used by the second RAT, canceling the signal associated with the second RAT from other received signals, or a combination thereof.

8. The method of claim 1, wherein the first RAT is a WWAN RAT, and the second RAT is a WLAN RAT.

9. The method of claim 8, wherein the WWAN RAT is configured to support long term evolution (LTE) communications over the communications medium using the unlicensed frequency spectrum, and wherein the WLAN RAT is configured to support Wi-Fi communications over the communications medium using the unlicensed frequency spectrum.

10. The method of claim 1, wherein the first RAT is a WLAN RAT, and the second RAT is a WWAN RAT.

11. The method of claim 10, wherein the WWAN RAT is configured to support LTE communications over the communications medium using the unlicensed frequency spectrum, and wherein the WLAN RAT is configured to support Wi-Fi communications over the communications medium using the unlicensed frequency spectrum.

12. An apparatus for processing signals from various radio access technologies (RATs), comprising:
a signal decoding component configured to decode, in a receiver configured for processing one or more signals associated with a first RAT, a signal associated with a second RAT, wherein the one or more signals associated with the first RAT and the signal associated with the second RAT are received over a communications medium that uses an unlicensed frequency spectrum;
a characteristics evaluating component configured to identify one or more characteristics in a waveform of the decoded signal as at least one of a pilot pattern, a reference signal pattern, or a combination thereof; and
a RAT determining component configured to determine that a RAT related to the decoded signal is the second RAT based at least in part on determining that at least one of the pilot pattern, the reference signal pattern, or the combination thereof, corresponds to the second RAT.

13. The apparatus of claim 12, wherein the second RAT is a wireless local area network (WLAN) RAT, and the RAT determining component is configured to determine that the RAT is the second RAT based at least in part on determining that at least one of the pilot pattern, the reference signal pattern, or the combination thereof, includes one or more pilot tones at fixed subcarrier locations within the waveform.

14. The apparatus of claim 12, wherein the second RAT is a wireless wide area network (WWAN) RAT, and the RAT determining component is configured to determine that the RAT is the second RAT based at least in part on determining that at least one of the pilot pattern, the reference signal pattern, or the combination thereof, includes pilot tones at subcarrier locations within the waveform corresponding to a cell-specific reference signal (CRS) pattern.

15. The apparatus of claim 12, wherein the characteristics evaluating component is configured to identify the one or more characteristics as an inter-packet spacing in the waveform of the decoded signal, and wherein the RAT determining component is configured to determine that the RAT is the second RAT further based at least in part on determining that the inter-packet spacing of the waveform corresponds to the second RAT.

16. The apparatus of claim 15, wherein the second RAT is a WLAN RAT, and the inter-packet spacing of the waveform comprises an inter-frame space (IFS) associated with the WLAN RAT.

17. The apparatus of claim 12, wherein the characteristics evaluating component is configured to identify the one or more characteristics as a preamble pattern comprising at least one of short training fields, long training fields, or a combination thereof, and wherein the RAT determining component is configured to determine that the RAT is the second RAT further based at least in part on detecting the preamble pattern.

18. The apparatus of claim 12, further comprising a signal processing component configured to perform, based at least in part on determining that the RAT is the second RAT, at least one of determining a level of utilization of the communications medium by the second RAT, determining a channel selection used by the second RAT, canceling the signal associated with the second RAT from other received signals, or a combination thereof.

19. An apparatus for processing signals from various radio access technologies (RATs), comprising:
means for decoding, in a receiver configured for processing one or more signals associated with a first RAT, a signal associated with a second RAT, wherein the one or more signals associated with the first RAT and the signal associated with the second RAT are received over a communications medium that uses an unlicensed frequency spectrum;
means for identifying one or more characteristics in a waveform of the decoded signal as at least one of a pilot pattern, a reference signal pattern, or a combination thereof; and
means for determining that a RAT related to the decoded signal is the second RAT based at least in part on determining that at least one of the pilot pattern, the reference signal pattern, or the combination thereof, corresponds to the second RAT.

20. The apparatus of claim 19, wherein the second RAT is a wireless local area network (WLAN) RAT, and the means for determining that the RAT is the second RAT is configured to determine that the RAT is the second RAT based at least in part on determining that at least one of the pilot pattern, the reference signal pattern, or the combination thereof includes one or more pilot tones at fixed subcarrier locations within the waveform.
